(19) United States
(12) Patent Application Publication
(10) Pub. No.: US 2026/0324651 A1
(43) Pub. Date: Oct. 22, 2026

(54) Bacillus Strain, Variants Thereof, Fermentation Products and Compositions Thereof for Inhibition of Plant Diseases

(71) Applicant: CHR HANSEN A/S, Hoersholm (DK)

(72) Inventors: Patricia Dominguez CUEVAS, Hoersholm (DK); Edward ROJAS, Hoersholm (DK); Thomas ECKHARDT, Hoersholm (DK); Cesar FONSECA, Hoersholm (DK); Iuliana NITA, Hoersholm (DK)

(73) Assignee: CHR HANSEN A/S, Hoersholm (DK)

(21) Appl. No.: 19/104,626

(22) PCT Filed: Aug. 28, 2023
(86) PCT No.: PCT/EP2023/073529

§ 371 Date: Feb. 18, 2025

(30) Foreign Application Priority Data
Aug. 30, 2022 (EP) 22192715.5

(51) Int. Cl. A01N 63/22; A01N 25/12; A01P 3/00

(52) U.S. Cl. CPC A01N 63/22; A01N 25/12; A01P 3/00

(57) ABSTRACT

The present invention relates to the use of bacteria for inhibition of plant diseases. In particular, the present invention relates to the use of a Bacillus amyloliquefaciens strain and variants thereof, fermentation products and compositions thereof capable of inhibiting growth of phytopathogens, such as fungi including Fusarium graminearum, Fusarium culmorum and Botrytis cinerea.

### TECHNICAL FIELD OF THE INVENTION

The present invention relates to the use of bacteria for inhibition of plant diseases. In particular, the present invention relates to the use of a Bacillus amyloliquefaciens strain and variants thereof, fermentation products and compositions thereof capable of inhibiting growth of phytopathogens, such as fungi including Fusarium graminearum, Fusarium culmorum and Botrytis cinerea.

### BACKGROUND OF THE INVENTION

The annual global production of four major crops; maize, wheat, rice and barley, are ca. 1110 million metric tons, ca. 750 million metric tons, ca. 500 million metric tons and ca. 150 million metric tons, respectively. The rapid population growth combined with climate change create a big challenge for crop production and yield globally. On one hand, there is an increasing demand of agricultural yield while on the other hand various biotic and abiotic issues significantly reduce crop production.

Among the plant diseases, fungal pathogens are the biggest global threat causing huge losses in agriculture and food production. Fungal pathogens, Fusarium graminearum, Fusarium culmorum, and other Fusarium spp. Fungi, causes fusarium head blight (FHB), which is a devastating crop disease on maize, wheat, rice and barley causing billions of dollars in economic losses worldwide annually. These fungi contaminate seeds of the above-mentioned crops mainly with two types of mycotoxins; trichothecene deoxynivalenol and zearalenone, which are produced during infection. Furthermore, both mycotoxins have hazardous effects on human and animal health. The Fusarium spp. spores are often present in soils, can remain there for several seasons and reinfect the plants. FHB symptoms are seen as discoloration or yellowing of glumes and spikelets after flowering.

Various strategies have been implemented to inhibit and control phytopathogens, such as Fusarium graminearum and Fusarium culmorum, including application of chemical fungicides, crop rotation, seed treatment etc. Even though the correct usage of fungicide at an early heading date can reduce the disease such as FHB by 50-60%, application of fungicides is challenging due to overlapping of different developmental stages within the crop. FHB disease generally develops late in the season or also during storage of the crops/seeds indicating that early application of fungicides might only be partially effective. Furthermore, prolonged use of chemically synthesized fungicides reduce microbial biodiversity in soil, increases pathogen resistance and generally degrades the soil quality.

Botrytis cinerea is an airborne fungal pathogen causing gray mold in flowers and fruits of plants, particularly at the end of the flowering or fruit-ripening period and is a devastating disease for fruits, vegetables and ornamental crops. The fungi can overwinter on crop debris where spring temperatures and rain initiate the sporulation process. These spores are transported by wind and rain to the flowers and fruits of host plants. Usual symptoms include spotting, discoloration and rotting of fruits. Additionally, the fungus rapidly sporulates over infected tissue creating a black or gray velvety mold and spreading to neighboring plants. Gray mold is the most serious of all fungal diseases and repeated application of fungicide is necessary to control the disease, especially in mild and humid climates. Due to limited broad-spectrum active ingredients, chemical control of Botrytis cinerea highly relies on fungicides with specific modes of action. This is pushing the development of Botrytis populations with low sensitivity to fungicides in greenhouses and fields. Therefore, there is an increasing need for improved and sustainable solutions for controlling the occurrence of Botrytis cinerea in plants. As evident from the above, the conventional treatment and control of FHB and gray mold requires different strategies and fungicides, which often are not fully effective.

It is therefore desirable to develop products and control and/or treatment methodologies that can easily be implemented in standard agriculture for combatting these phytopathogens, preferentially with one broad-range product. One such standard methodology is the application of a biocontrol product to the foliage of the crops, e.g. by spraying of the plants.

Plant and soil microbes interact to help each other for their growth and development as well as to maintain the terrestrial eco-system. Plants can also use these growth promoting microbes as weapon against various phytopathogens including fungi, as microbes have great potential to produce and secrete various bioactive molecules that can act against the phytopathogens, such as fungal pathogens.

Growth promoting microbes include Bacillus which are Gram-positive bacteria characterized by having thick cell walls and the absence of outer membranes. Much of the cell wall of Gram-positive bacteria is composed of peptidoglycan. Gram-positive species are divided into groups according to their morphological and biochemical characteristics. The genus Bacillus is belonging to the group of sporulating bacteria. Bacterial spores are one of the most resilient cell types; they resist many environmental changes, withstand dry heat and certain chemical disinfectants and may persist for years on dry land.

Accordingly, Bacillus industrial strains are routinely applied in various plant health products for plantations. Many of these industrial Bacillus strains produce/secrete various classes of bioactive metabolites, for example non-ribosomal polyketide synthases (NRPS), polyketides, siderophores, antibiotics, surfactants, hydrolytic enzymes (e.g., protease, lipase, etc.), volatile compounds, etc.

Lipopeptides (e.g. surfactins, iturins, fengycins and the like) have proved to be bioactive metabolites in fermentation products from Bacillus strains able to inhibit growth of phytopathogens, e.g. acting as biofungicides against FHB and gray mold. However, the available industrial Bacillus strains, fermentation products and compositions containing those, have limited efficacy against FHB and gray mold. There is a need for more efficient Bacillus strains, fermentation products and compositions containing those, for combating phytopathogens, including those causing fungal diseases such as FHB and gray mold. Provision of more efficient Bacillus strains, fermentation products or compositions containing those, would come with significant economic savings and improve the ability to meet the increasing global demands for crop production as the world population grow.

Furthermore, besides the direct antagonism mechanisms related to the various classes of bioactive metabolites produced by Bacillus strains, some beneficial bacteria can protect plants indirectly through the stimulation of the plant defense mechanisms, also known as induced systemic resistance (ISR). Elicitation of the ISR renders plants more resistant to pathogen infection. Protection resulting from ISR elicited by Bacillus spp. has been reported against both fungal and bacterial pathogens. It is contemplated that the Bacillus strains, or compositions containing those, as described herein are able to also stimulate ISR in the plants after having been applied to the plants or the habitat, preferably applied to the foliage.

Thus, there is an unmet need for identifying more efficient strains of Bacillus and fermentation products able to be used to combat phytopathogens and methods for their use to improve plant health and yield of crops without utilizing hazardous chemical fungicides. In particular, there is a need for an effective biocontrol product that can easily be applied to the foliage of the crops.

Hence, it would be advantageous to provide and use Bacillus strains, fermentation products and compositions containing those, with high efficacy in the inhibition of phytopathogens, such as Fusarium graminearum, Fusarium culmorum and Botrytis cinerea. Specifically, it would be advantageous to provide compositions of Bacillus strains and fermentation products containing high concentrations of bioactive (antifungal) metabolites, such as lipopeptides, that may be utilized as efficient and climate friendly solutions for improving crop yield.

### SUMMARY OF THE INVENTION

The present invention relates to the identification of a Bacillus strain, variants thereof, fermentation products and compositions thereof, that are effective in inhibiting phytopathogens. In particular, herein are identified a Bacillus strain and fermentation product which, in a composition, may be applied to plants or the habitat, preferably the foliage, of the plant to significantly improve plant health and growth compared to known biofungicide treatments. Accordingly, the present invention makes available a Bacillus strain, fermentation products and compositions of those, to combat phytopathogens, such as Fusarium graminearum, Fusarium culmorum and Botrytis cinerea to reduce the need for chemical fungicides.

Thus, an object of the present invention relates to the provision and use of a Bacillus strain and respective fermentation products or a composition comprising those capable of inhibiting plant disease without using chemical fungicides.

Another object of the present invention relates to the use of Bacillus strain and respective fermentation products with a lipopeptide profile for combatting fungal disease in plants.

The Bacillus strain, a fermentation product, or a composition comprising those, may be readily used for direct application to the foliage of plants and/or for application to the habitat of plants. Preferably, the application is to the foliage of plants.

Thus, an aspect of the present invention relates to use of a composition for inhibiting growth of one or more phytopathogens on a plant, said composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Another aspect of the present invention relates to a method of inhibiting growth of one or more phytopathogens on a plant, wherein the method comprises applying to said plant a composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

A further aspect of the present invention relates to a kit for use in inhibiting growth of one or more phytopathogens on a plant, said kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

A still further aspect of the present invention relates to a kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and wherein the kit is for use in inhibiting growth of one or more phytopathogens on a plant.

### BRIEF DESCRIPTION OF THE FIGURES

FIG. 1 shows growth inhibition of phytopathogenic filamentous fungi F. graminearum by fermentation products from B. amyloliquefaciens strain DSM34003 (FUNGI-FOL) or from commercial strains. (A) Bioactivity levels (ID50s) compared between FUNGI-FOL and fermentation products from commercial strains. (B) Bioactivity levels (ID50s) compared between commercial products and the FUNGI-FOL prototype product (concentrated fermentation product).

FIG. 2 shows growth inhibition (bioactivity levels, ID50s) of phytopathogenic filamentous fungi B. cinerea by FUNGI-FOL or fermentation products from commercial strains.

FIG. 3 shows quantification of the three lipopeptide families' levels, fengycins, surfactins and iturins, comprised in the FUNGI-FOL prototype product.

FIG. 4 shows the inhibitory effect of lipopeptides on two different phytopathogenic species. (A) Inhibition of surfactin on F. culmorum (left) and B. cinerea (right). (B) Inhibition of fengycin on F. culmorum (left) and B. cinerea (right). (C) Inhibition of iturin on F. culmorum (left) and B. cinerea (right).

FIG. 5 shows the inhibitory effect of the combination of surfactin and fengycin on growth of (A) F. culmorum and (B) B. cinerea.

FIG. 6 shows the effect of treatment with FUNGI-FOL or commercially available biocontrol products on spring wheat plants exposed to FHB. (A) Disease severity as function of dilutions of FUNGI-FOL applied. Comparison of disease incidence (B) and disease severity (C) with commercially available biocontrol products.

### DETAILED DESCRIPTION OF THE INVENTION

### Definitions

Prior to outlining the present invention in more details, a set of terms and conventions is first defined:

### Inhibitory Effect/Inhibition of Growth

In the present context, the term “inhibitory effect” or “inhibition of growth” refers to the ability of a microorganism to kill or reduce the growth of a phytopathogen. Accordingly, the inhibitory effect or inhibition of growth may be determined by quantifying the amount of the phytopathogen upon exposure to the microorganism.

### Phytopathogen

In the present context, the term “phytopathogen” refers to any microorganism that is pathogenic to plants. In particular, phytopathogens include, but are not limited to, fungi and bacteria.

### Identifying Characteristics

In the present context, the term “identifying characteristics” refers to the phenotype of a microorganism, i.e. the set of observable characteristics or traits of the microorganism. Particularly, the identifying characteristic can be the inhibitory effect on a phytopathogen and/or production of one or more metabolites. The metabolite may be a lipopeptide, such as compounds belonging to the iturins, fengycins and/or surfactins families.

Microorganisms sharing all identifying characteristics can have different non-identical genomic sequences. This may be the case if mutations are silent or conservative, i.e. the new codon gives rise to the same amino acid or the new amino acid have similar biochemical properties (e.g. charge or hydrophobicity), respectively.

### Variant or Variant Strain

In the present context, the term “variant” or “variant strain” refers to a strain which is functionally equivalent to a strain of the invention, e.g. having substantially the same properties (e.g. regarding the inhibitory ability against phytopathogens). Such variants, which may be identified using appropriate screening techniques or by strain development or mutagenesis, are a part of the present invention.

Accordingly, variants strains as referred to herein shares the same identifying (phenotypic) characteristics as Bacillus amyloliquefaciens strain DSM34003. Such variant strains may have genotypic modifications to Bacillus amyloliquefaciens strain DSM34003 with no or minor phenotypic changes and are as such also considered to be part of the invention.

### Fermentation Product

In the present context, the term “fermentation product” refers to the bacterial culture containing media components, compounds secreted by the bacterial cells resulting from metabolism, such as lipopeptides, polyketides and enzymes, and products from transformations of compounds present in the media or secreted by the bacterial cells. The fermentation product may also contain bacterial cells, in the vegetative and/or spore form and cell debris.

### Metabolite

In the present context, the term “metabolite” refers to any substance produced as an intermediate or end product by a microorganism. Metabolites can be small molecules of low molecular weight that influence biological processes and impact a variety of functions including, but not limited to, inhibitory effects on pathogens, catalytic activity, defensive mechanisms or other interactions with other organisms.

The metabolites with activity against fungal phytopathogens are, in the present context, termed “bioactive metabolites”. One group of bioactive metabolites are lipopeptides, such as iturins, fengycins and surfactins. Other groups of bioactive metabolites include, but are not limited to, polyketides and volatile compounds (VOCs).

### Plant Biostimulant

In the present context, the term “plant biostimulant” refers to any substance or microorganism applied to plants with the ability to enhance nutrition efficiency, abiotic stress tolerance and/or crop quality traits, regardless of its nutrients content. By extension, plant biostimulants also designate commercial products containing mixtures of such substances and/or microorganisms. Microorganisms with biostimulant properties may be referred to as biostimulant strains.

### Plant Growth Promoting Agent

In the present context, the term “plant growth promoting agent” or “plant growth promoting microorganism” refers to a composition comprising a microorganism and/or the fermentation product produced by the microorganism with the ability to colonize aerial plant surfaces (leaves, stems, flowers, fruits) and/or inner plant tissues and promote plant growth and health by either acting as a biofertilizer, biostimulant, biocontrol agent, or via biological control of plant disease.

### About

Wherever the term “about” is employed herein in the context of amounts, for example absolute amounts, such as numbers, purities, weights, concentrations, sizes, etc., or relative amounts (e.g. percentages, equivalents or ratios), timeframes, and parameters such as temperatures, pressure, etc., it will be appreciated that such variables are approximate and as such may vary by ±10%, for example ±5% and preferably ±2% (e.g. ±1%) from the actual numbers specified. This is the case even if such numbers are presented as percentages in the first place (for example ‘about 10%’ may mean ±10% about the number 10, which is anything between 9% and 11%).

### Bacillus Strain and Variants Thereof

Plantations are globally faced with the challenge of maximizing agricultural yield in order to meet the steep global demands of large quantities of goods produced in an environmentally satisfactory manner. However, phytopathogens remains a significant issue causing devastating losses in yield worldwide. While phytopathogens may be combatted with some effect by application of chemicals such as fungicides, these solutions are not preferred as the applied compounds may have hazardous effects on human and animal health as well as negatively impacting the environment. Therefore, solutions based on application of natural organisms are in demand.

Herein is identified and used a Bacillus strain of the species Bacillus amyloliquefaciens, which fermentation products and compositions of those have a surprisingly high inhibitory effect on phytopathogens, such as Fusarium graminearum, Fusarium culmorum and Botrytis cinerea. The Bacillus amyloliquefaciens strain has been deposited as DSM34003. It is contemplated that the identified strain of Bacillus amyloliquefaciens and corresponding fermentation product (the combination of which will be referred to as “FUNGI-FOL” herein) will aid in combatting the challenges of improving plant health and crop yield in an environmentally compelling manner.

Thus, an aspect of the present invention relates to use of a composition for inhibiting growth of one or more phytopathogens on a plant, said composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

It is to be understood that Bacillus amyloliquefaciens strains with identical or similar phenotypes also forms part of the invention. These may be obtained by classical strain improvement (CSI) techniques, induced mutagenesis, or directed genome engineering to produce new mutants or variants with identical or similar phenotypes. Such strains may be said to have all of the identifying characteristics of the derivative strains disclosed herein. Accordingly, strains sharing all identifying characteristics can have different non-identical genomic sequences. The identifying characteristics may include, but is not limited to, the ability to inhibit a phytopathogen and/or increased production of one or more metabolites.

Thus, an embodiment of the present invention relates to the use as described herein, wherein a variant of the Bacillus amyloliquefaciens strain encompass all the identifying characteristics of the Bacillus amyloliquefaciens strain.

Another embodiment of the present invention relates to the use as described herein, wherein the identifying characteristics of the Bacillus amyloliquefaciens strain includes the fermentation product comprising metabolites, such as lipopeptides. Preferably, the levels and/or combination of metabolites, such as lipopeptides (iturins, fengycins and surfactins), are more favorable for the inhibition of phytopathogenic fungi than other Bacillus strains.

Since secreted bioactive metabolites, such as lipopeptides, contribute to the inhibitory activity, the composition may include the fermentation product of said Bacillus amyloliquefaciens strain. Preferably, the composition comprises both the Bacillus amyloliquefaciens strain and the fermentation product thereof.

Thus, an embodiment of the present invention relates to the use as described herein, wherein the composition comprises the fermentation product produced by the Bacillus amyloliquefaciens strain or a variant thereof.

A preferred embodiment of the present invention relates to the use as described herein, wherein the composition comprises:
(i) the Bacillus amyloliquefaciens strain or a variant thereof, and
(ii) the fermentation product produced by the Bacillus amyloliquefaciens strain or a variant thereof.

It is demonstrated herein that the FUNGI-FOL composition comprising the Bacillus amyloliquefaciens strain DSM34003 and the respective fermentation product thereof effectively inhibits phytopathogens causing disease to the foliage of plants. Accordingly, the composition may preferably be applied directly to the plant or part of the plant to protect the plant against attacks by a phytopathogen. Application may be accomplished by spraying the composition onto the foliage of the plants. This type of application may be referred to as foliar application and can typically be implemented in most agricultural settings without the need for investment in additional equipment.

Thus, an embodiment of the present invention relates to the use as described herein, wherein the composition is applied to one or more aerial surfaces of the plant.

Another embodiment of the present invention relates to the use as described herein, wherein the aerial surfaces of the plant are selected from the group consisting of leaves, stems, flowers, fruits or combinations thereof.

A further embodiment of the present invention relates to the use as described herein, wherein the composition is applied to the plant by spraying.

The Bacillus amyloliquefaciens strain, fermentation products thereof and compositions of those, disclosed herein have high inhibitory activity against phytopathogens that are known to commonly cause disease to plants and reduce health and yield of crops. These phytopathogens include a range of plant fungal and plant bacterial pathogens, and in particular those belonging to the genus Fusarium and Botrytis. Without being bound by theory, it is contemplated that primarily the high production of bioactive metabolites, such as lipopeptides, are responsible for the increased antifungal activity of the Bacillus amyloliquefaciens strain.

Thus, an embodiment of the present invention relates to the use as described herein, wherein the one or more phytopathogens are one or more plant fungal pathogens or plant bacterial pathogens, or combinations thereof.

Another embodiment of the present invention relates to the use as described herein, wherein the one or more plant fungal pathogens or plant bacterial pathogens are from a genus selected from the group consisting of Fusarium, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phytophthora, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Ustilago, Claviceps, Tilletia, Phoma, Cochliobolus, Gaeumanomyces, Rhychosporium, Biopolaris, and Helminthosporium, and combinations thereof.

Yet another embodiment of the present invention relates to the use as described herein, wherein the one or more plant fungal pathogens or plant bacterial pathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum, Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizoctonia solani, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.

A further embodiment of the present invention relates to the use as described herein, wherein the one or more phytopathogens are one or more plant fungal pathogens.

Fungal pathogens of particular importance to the agricultural industry include Fusarium graminearum and Fusarium culmorum which causes the disease Fusarium Head Blight (FHB) that in turn can be devastating to the yield of crops. Also, Botrytis cinerea, which causes gray mold, is a fungal pathogen with huge economical impact as large quantities of diseased crops are discarded every year due to mold. Preventing these fungal pathogens from infecting plants are therefore of great importance.

Thus, an embodiment of the present invention relates to the use as described herein, wherein the one or more plant fungal pathogens are from a genus selected from Fusarium or Botrytis.

Another embodiment of the present invention relates to the use as described herein, wherein the one or more plant fungal pathogens are Fusarium graminearum, Fusarium culmorum or Botrytis cinerea.

Yet another embodiment of the present invention relates to the use as described herein, wherein the one or more plant fungal pathogens is Fusarium graminearum.

A further embodiment of the present invention relates to the use as described herein, wherein the one or more plant fungal pathogens is Fusarium culmorum.

A still further embodiment of the present invention relates to the use as described herein, wherein the one or more plant fungal pathogens is Botrytis cinerea.

Gram-positive bacteria, such as Bacillus, are capable of forming spores, typically in the form of intracellular spores called endospores, as a surviving mechanism. These endospores are very retractile and thick-walled structures that constitute the most dormant form of bacteria as they exhibit minimal metabolism, respiration and enzyme production. Such bacterial spores are highly resistant to temperature fluctuations, chemical agents, UV radiation, pH gradients, drought and nutrition depletion. As the surrounding environment favors bacterial proliferation, the bacterial spores will germinate back into vegetative cells, i.e. an active bacterial cell undergoing metabolism.

Accordingly, spore-forming bacteria are preferred in the present context as they possess the ability to lay dormant if conditions in the field does not favor survival. Thus, the risk of losing the biostimulant Bacillus amyloliquefaciens strain after application to the plant is reduced for spore-forming bacteria. Accordingly, the Bacillus amyloliquefaciens strain disclosed herein has been positively selected for spore-formation ability.

Therefore, an embodiment of the present invention relates to the use as described herein, wherein the Bacillus amyloliquefaciens strain is in the form of spores or vegetative cells.

The composition may preferably comprise said Bacillus amyloliquefaciens strain in the form of spores as this increases stability and longevity of the composition, especially when applied under harsh conditions, such as drought or the like.

Accordingly, an embodiment of the present invention relates to the use as described herein, wherein the Bacillus amyloliquefaciens strain is in the form of spores.

Bacillus strains produce a range of bioactive metabolites, i.e. those metabolites that are inhibitory to other organisms, like phytopathogenic fungi. One group of bioactive metabolites are the lipopeptides, which consist of a lipid moiety connected to a peptidic moiety. Lipopeptides acts as biosurfactants and may have antibiotic activity, e.g. fungicidal activity. It is contemplated that the Bacillus amyloliquefaciens strain of FUNGI-FOL identified and used herein has a favorable expression and secretion profile of bioactive metabolites which enhance its biofungicide effect.

Therefore, an embodiment of the present invention relates to the use as described herein, wherein the fermentation product comprises one or more metabolites.

A group of lipopeptides known to have antifungal activity are the cyclic lipopeptides. This group includes iturins, fengycins and surfactins, which all share a common structure consisting of a lipid tail linked to a short cyclic peptide. The variants of compounds in each group come from different amino acid components. Iturins and fengycins are known to have strong antifungal activity, whereas surfactins do not on their own exhibit great antifungal toxicity. However, surfactins may promote the antifungal activity of other lipopeptides.

An embodiment of the present invention relates to the use as described herein, wherein the metabolites are lipopeptides.

Another embodiment of the present invention relates to the use as described herein, wherein the lipopeptides are selected from the group consisting of iturins, fengycins and surfactins, and combinations thereof.

The inventors have found that surfactins works synergistically with other lipopeptides, such as fengycins and iturins, to produce a strong inhibitory effect on growth of phytopathogens, such as fungal pathogens. Without being bound by theory, it is therefore suggested herein that Bacillus strains promoting elevated levels of surfactins can provide a superior inhibitory effect. Preferably, such a Bacillus strain is capable of producing also increased levels of other lipopeptides, such as fengycins and iturins.

Thus, an embodiment of the present invention relates to the use as described herein, wherein said Bacillus amyloliquefaciens strain or a variant thereof is capable of producing elevated levels of lipopeptides, such as surfactins, fengycins and/or iturins. Another embodiment of the present invention relates to the use as described herein, wherein said a Bacillus amyloliquefaciens strain or a variant thereof is capable of producing elevated levels of surfactins and/or fengycins, preferably surfactins and fengycins.

A further embodiment of the present invention relates to the use as described herein, wherein the lipopeptides comprise fengycins and iturins.

A still further embodiment of the present invention relates to the use as described herein, wherein the lipopeptides comprise surfactins and fengycins.

An even further embodiment of the present invention relates to the use as described herein, wherein the lipopeptides comprise surfactins and iturins.

The production of the one or more metabolites may be quantified by liquid chromatography-mass spectrometry (LC-MS).

An embodiment of the present invention relates to the use as described herein, wherein the total concentration of lipopeptides in the fermentation product is about 2500-30000 μg/ml in a medium originally containing 30 mol/L of carbon source.

It is to be understood that that the total concentration of lipopeptides as used herein refers to the total concentration of surfactins, fengycins and iturins combined.

Another embodiment of the present invention relates to the use as described herein, wherein the concentration of surfactins in the fermentation product is about 1200-15000 μg/ml.

A further embodiment of the present invention relates to the use as described herein, wherein the concentration of fengycins in the fermentation product is about 700-6500 μg/ml.

A still further embodiment of the present invention relates to the use as described herein, wherein the concentration of iturins in the fermentation product is about 500-4500 μg/ml.

The composition comprising the Bacillus amyloliquefaciens strain and/or fermentation product produced by the strain will for most practical purposes also comprise other components to improve stability, deliverability or otherwise improve the performance as a plant growth promoting agent. Many of such additional components may be standard ingredient that are typically used in formulations of plant growth promoting agents, plant biostimulants, or biofungicides.

Therefore, an embodiment of the present invention relates to the use as described herein, wherein the composition further comprises one or more agrochemically acceptable excipients carriers, surfactants, dispersants and yeast extracts.

Besides any agrochemically acceptable standard ingredients, the composition may comprise additional active ingredients. Additional active ingredients may be, but is not necessarily, of different origin than microbial. They can increase the potency of the composition either by supplementing the inhibitory activity of the Bacillus amyloliquefaciens strain and/or the respective fermentation product thereof with a different effect or by working in synergy with the Bacillus amyloliquefaciens strain and/or the respective fermentation product. Different effects include, but are not limited to, inhibition of other phytopathogens, such as insects or nematodes, or stimulating growth by provision of nutrients.

Therefore, an embodiment of the present invention relates to the use as described herein, wherein the composition further comprises one or more active ingredients.

Another embodiment of the present invention relates to the use as described herein, wherein the one or more active ingredients are of microbial, biological or chemical origin.

Yet another embodiment of the present invention relates to the use as described herein, wherein the one or more active ingredients are selected from the group consisting of an insecticide, fungicide, nematicide, bactericide, herbicide, plant extract, plant growth regulator, a plant growth stimulator, and fertilizer.

A further embodiment of the present invention relates to the use as described herein, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.

A still further embodiment of the present invention relates to the use as described herein, wherein the fungicide is selected from the group consisting of fluopyram plus tebuconazole, chlorothalonil, thiophanate-methyl, prothioconazole, metalaxyl, and copper hydroxide, and combinations thereof.

A preferred variation of the composition combines FUNGI-FOL as disclosed herein with a different strain of bacteria. The second bacterial strain may function as a plant biostimulant or plant growth promoting agent.

Accordingly, an embodiment of the present invention relates to the use as described herein, wherein the one or more active ingredients are selected from a second strain of bacteria different from the Bacillus amyloliquefaciens strain.

Another embodiment of the present invention relates to the use as described herein, wherein said second strain of bacteria is a biostimulant strain, preferably a biostimulant Bacillus strain.

A further embodiment of the present invention relates to the use as described herein, wherein said second strain of bacteria is of a species selected from the group consisting of Bacillus velezensis, Bacillus paralicheniformis, Bacillus amyloliquefaciens, and Bacillus subtilis.

The composition disclosed herein may be in the form of a liquid, a wettable powder, a granule, a spreadable granule, a wettable granule, a microencapsulation, and a planting matrix or any technically feasible formulation that may include suitable agrochemically acceptable components. Alternatively, the composition may also be provided as an oil formulation, such as a water in oil (W/O) emulsion, an oil in water (O/W) emulsion, a microemulsion, or an oil dispersion. For foliar application of the composition to a plant it is preferred that the composition is in liquid form.

Therefore, an embodiment of the present invention relates to the use as described herein, wherein the composition is in a form selected from the group consisting of a liquid, a wettable powder, a granule, a spreadable granule, a wettable granule, and a microencapsulation.

A preferred embodiment of the present invention relates to the use as described herein, wherein the composition is a liquid formulation.

To further improve the stability and longevity of the Bacillus amyloliquefaciens strain and any other sensitive ingredient or components included in the composition it may benefit to include a coating polymer. Such polymer may shield bacterial strains from hostile environment conditions. In one variation, bacterial spores of the Bacillus amyloliquefaciens strain is coated to improve durability of the microorganism

Thus, an embodiment of the present invention relates to the use as described herein, wherein the composition further comprises a coating polymer.

Plants that could be the beneficiary of the inhibitory effect of the composition comprising the Bacillus amyloliquefaciens strain and/or the fermentation product thereof on phytopathogens could in principle include any plant that may attract a phytopathogen. Typically, the use of the composition for inhibiting growth of one or more phytopathogens on a plant as disclosed herein is mainly relevant for agriculture, because relatively small improvements in yield can make a great difference in an industrial setting. Moreover, the prospect of being able to improve yield in a climate-friendly manner is attractive and stands in stark contrast to the traditional image of modern agronomy polluting the environment with agrochemicals that cause widespread ecological damage.

Accordingly, an embodiment of the present invention relates to the use as described herein, wherein the plant is selected from the group consisting of a crop, a monocotyledonous plant, a dicotyledonous plant, a tree, an herb, a bush, a grass, a vine, a fern, and a moss.

Within this grouping of plants are found a large and diverse selection of plants that are commercialized in one way or another, which include, but is not limited to, corn, sweet corn, popcorn, seed corn, silage corn, field corn, rice, wheat, barley, sorghum, asparagus, berry, blueberry, blackberry, raspberry, loganberry, huckleberry, cranberry, gooseberry, elderberry, currant, caneberry, bush berry, brassica vegetables, broccoli, cabbage, cauliflower, brussels sprouts, collards, kale, mustard greens, kohlrabi, bulb vegetables, onion, garlic, shallots, citrus, orange, grapefruit, lemon, tangerine, tangelo, pomelo, fruiting vegetables, pepper, avocado, tomato, eggplant, ground cherry, tomatillo, okra, grape, herbs/spices, cucurbit vegetables, cucumber, cantaloupe, melon, muskmelon, squash, watermelon, pumpkin, leafy vegetables, lettuce, celery, spinach, parsley, radicchio, legumes/vegetables (succulent and dried beans and peas), beans, green beans, snap beans, shell beans, soybeans, dry beans, garbanzo beans, lima beans, peas, chick peas, split peas, lentils, oil seed crops, canola, castor, coconut, cotton, flax, oil palm, olive, peanut, rapeseed, safflower, sesame, sunflower, soybean, pome fruit, apple, crabapple, pear, quince, mayhaw, root/tuber and corm vegetables, carrot, potato, sweet potato, beets, ginger, horseradish, radish, ginseng, turnip, stone fruit, apricot, cherry, nectarine, peach, plum, prune, strawberry, tree nuts, almond, pistachio, pecan, walnut, filberts, chestnut, cashew, beechnut, butternut, macadamia, kiwi, banana, agave, tobacco, ornamental plants, poinsettia, hardwood cuttings, oak, maple, sugarcane, sugarbeet, grass, or turf grass. The method of inhibiting growth of one or more phytopathogens on a plant is applicable to any of these plants.

Given the efficiency of the composition disclosed herein against Fusarium and Botrytis, it is preferred to apply the composition to plants that are prone to contract FHB and/or gray mold.

Thus, a preferred embodiment of the present invention relates to the use as described herein, wherein the plant is selected from the group consisting of wheat, barley, oats, small cereal grains, corn, rice, sugar cane, soybean, potato, carrot, coffee and banana.

A preferred embodiment relates to the use as described herein, wherein the plant is wheat.

Based on evidence presented herein, it is contemplated that the use of the composition as disclosed herein will incur many advantageous effects to the plants onto which the composition is applied. Overall, plant health is expected to improve and thereby increase the yield of the crops.

Therefore, an embodiment of the present invention relates to the use as described herein, wherein inhibiting growth of one or more phytopathogens leads to improve seedling vigor, improved root development, improved plant growth, improved plant health, increased yield, improved appearance, reduced pathogenic infection, or a combination thereof.

Another aspect of the present invention relates to a method of inhibiting growth of one or more phytopathogens on a plant, wherein the method comprises applying to said plant a composition comprising:
(i) a Bacillus amyloliquefaciens strain or a variant thereof, and/or
(ii) a fermentation product produced by a Bacillus amyloliquefaciens strain or a variant thereof,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

The composition comprising the Bacillus amyloliquefaciens strain DSM34003 and/or the respective fermentation product produced by the strain may conveniently be provided in a container together with any potential other active ingredients that are suitable for use together or sequentially with the composition. Provision of any additional active ingredients may preferably be in separate compartments of the kit (or container) to ensure any adverse effects from long term storage of the composition with the additional ingredients. An example of an adverse effect is inadvertent competition between two different bacterial strains. Instructions may be included to guide the user in application and dosing of the composition and any other active ingredient.

Thus, an aspect of the present invention relates to a kit for use in inhibiting growth of one or more phytopathogens on a plant, said kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.

Another aspect of the present invention relates to a kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and wherein the kit is for use in inhibiting growth of one or more phytopathogens on a plant.

It is to be understood that the Bacillus strain and/or fermentation product in the kits can be applied to the foliage or any other aerial part of plants.

The listing or discussion of an apparently prior published document in this specification should not necessarily be taken as an acknowledgement that the document is part of the state of the art or is common general knowledge.

Preferences, options and embodiments for a given aspect, feature or parameter of the invention should, unless the context indicates otherwise, be regarded as having been disclosed in combination with any and all preferences, options and embodiments for all other aspects, features and parameters of the invention. This is especially true for the description of the use of the Bacillus amyloliquefaciens strain and all its features, which may readily be part of the part of the method or kit for inhibiting growth of a phytopathogen on a plant. It is clear from the disclosure herein that the composition may comprise Bacillus amyloliquefaciens strain DSM34003 and/or the fermentation product produced by the strain. Accordingly, it is to be understood that any discussion of the benefits achieved by use of Bacillus amyloliquefaciens strain DSM34003 can also be extrapolated to the fermentation product or to a combination of the strain and the corresponding fermentation product. Embodiments and features of the present invention are also outlined in the following items.

### Items

X1. Use of a composition for inhibiting growth of one or more phytopathogens on a plant, said composition comprising:
   (i) a Bacillus amyloliquefaciens strain or a variant thereof, and/or
   (ii) a fermentation product produced by a Bacillus amyloliquefaciens strain or a variant thereof,
      wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.
X2. The use according to item X1, wherein the composition comprises the fermentation product produced by the Bacillus amyloliquefaciens strain or a variant thereof.
X3. The use according to any one of items X1 or X2, wherein the composition comprises:
   (i) the Bacillus amyloliquefaciens strain or a variant thereof, and
   (ii) the fermentation product produced by the Bacillus amyloliquefaciens strain or a variant thereof.
X4. The use according to any one of the preceding items, wherein the composition is applied to one or more aerial surfaces of the plant.
X5. The use according to item X4, wherein the aerial surfaces of the plant are selected from the group consisting of leaves, stems, flowers, fruits or combinations thereof.
X6. The use according to any one of items X4 or X5, wherein the composition is applied to the plant by spraying.
X7. The use according to any one of the preceding items, wherein the one or more phytopathogens are one or more plant fungal pathogens or plant bacterial pathogens, or combinations thereof.
X8. The use according to item X7, wherein the one or more plant fungal pathogens or plant bacterial pathogens are from a genus selected from the group consisting of Fusarium, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phytophthora, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Ustilago, Claviceps, Tilletia, Phoma, Cochliobolus, Gaeumanomyces, Rhychosporium, Biopolaris, and Helminthosporium, and combinations thereof.
X9. The use according to any one of items X7 or X8, wherein the one or more plant fungal pathogens or plant bacterial pathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum, Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizoctonia solani, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.
X10. The use according to any one of the preceding items, wherein the one or more phytopathogens are one or more plant fungal pathogens.
X11. The use according to any one of items X7-X10, wherein the one or more plant fungal pathogens are Fusarium graminearum, Fusarium culmorum or Botrytis cinerea.
X12. The use according to any one of the preceding items, wherein the Bacillus amyloliquefaciens strain is in the form of spores or vegetative cells.
X13. The use according to any one of the preceding items, wherein the Bacillus amyloliquefaciens strain is in the form of spores.
X14. The use according to any one of the preceding items, wherein the fermentation product comprises one or more metabolites.
X15. The use according to item X14, wherein the metabolites are lipopeptides.
X16. The use according to item X15, wherein the lipopeptides are selected from the group consisting of iturins, fengycins and surfactins, and combinations thereof.
X17. The use according to any of items X15 or X16, wherein the lipopeptides comprise fengycins and iturins.
X18. The use according to any of items X15 or X16, wherein the lipopeptides comprise surfactins and fengycins.
X19. The use according to any of items X15 or X16, wherein the lipopeptides comprise surfactins and iturins.
X20. The use according to any of items X15-X19, wherein the total concentration of lipopeptides in the fermentation product is about 2500-30000 μg/ml in a medium originally containing 30 g/L of carbon source.
X21. The use according to any of items X16-X20, wherein the concentration of surfactins in the fermentation product is about 1200-15000 μg/ml.
X22. The use according to any of items X16-X21, wherein the concentration of fengycins in the fermentation product is about 700-6500 μg/ml.
X23. The use according to any of items X16-X22, wherein the concentration of iturins in the fermentation product is about 500-4500 μg/ml.
X24. The use according to any one of the preceding items, wherein the composition further comprises one or more agrochemically acceptable excipients carriers, surfactants, dispersants and yeast extracts.
X25. The use according to any one of the preceding items, wherein the composition further comprises one or more active ingredients.
X26. The use according to item X25, wherein the one or more active ingredients are of microbial, biological or chemical origin.
X27. The use according to any one of items X25 or X26, wherein the one or more active ingredients are selected from the group consisting of an insecticide, fungicide, nematicide, bactericide, herbicide, plant extract, plant growth regulator, a plant growth stimulator, and fertilizer.
X28. The use according to item X27, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.
X29. The use according to any one of items X27 or X28, wherein the fungicide is selected from the group consisting of fluopyram plus tebuconazole, chlorothalonil, thiophanate-methyl, prothioconazole, metalaxyl, and copper hydroxide, and combinations thereof.
X30. The use according to any one of items X25-X29, wherein the one or more active ingredients are selected from a second strain of bacteria different from the Bacillus amyloliquefaciens strain.
X31. The use according to item X30, wherein said second strain of bacteria is a biostimulant strain, preferably a biostimulant Bacillus strain.
X32. The use according to any one of items X30 or X31, wherein said second strain of bacteria is of a species selected from the group consisting of Bacillus velezensis, Bacillus paralicheniformis, Bacillus amyloliquefaciens, and Bacillus subtilis.
X33. The use according to any one of the preceding items, wherein the composition is in a form selected from the group consisting of a liquid, a wettable powder, a granule, a spreadable granule, a wettable granule, and a microencapsulation.
X34. The use according to any one of the preceding items, wherein the composition is a liquid formulation.
X35. The use according to any one of the preceding items, wherein the composition further comprises a coating polymer.
X36. The use according to any one of the preceding items, wherein the plant is selected from the group consisting of a crop, a monocotyledonous plant, a dicotyledonous plant, a tree, an herb, a bush, a grass, a vine, a fern, and a moss.
X37. The use according to any one of the preceding items, wherein the plant is selected from the group consisting of wheat, barley, oats, small cereal grains, corn, rice, sugar cane, soybean, potato, carrot, coffee and banana.
X38. The use according to any one of the preceding items, wherein inhibiting growth of one or more phytopathogens leads to improve seedling vigor, improved root development, improved plant growth, improved plant health, increased yield, improved appearance, reduced pathogenic infection, or a combination thereof.
Y1. A method of inhibiting growth of one or more phytopathogens on a plant, wherein the method comprises applying to said plant a composition comprising:
   (i) a Bacillus amyloliquefaciens strain or a variant thereof, and/or
   (ii) a fermentation product produced by a Bacillus amyloliquefaciens strain or a variant thereof,
      wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.
Y2. The method according to item Y1, wherein the composition comprises the fermentation product produced by the Bacillus amyloliquefaciens strain or a variant thereof.
Y3. The method according to any one of items Y1 or Y2, wherein the composition comprises:
   (i) the Bacillus amyloliquefaciens strain or a variant thereof, and
   (ii) the fermentation product produced by the Bacillus amyloliquefaciens strain or a variant thereof.
Y4. The method according to any one of items Y1-Y3, wherein the composition is applied to one or more aerial surfaces of the plant.
Y5. The method according to item Y4, wherein the aerial surfaces of the plant are selected from the group consisting of leaves, stems, flowers, fruits or combinations thereof.
Y6. The method according to any one of items Y4 or Y5, wherein the composition is applied to the plant by spraying.
Y7. The method according to any one of items Y1-Y6, wherein the one or more phytopathogens are one or more plant fungal pathogens or plant bacterial pathogens, or combinations thereof.
Y8. The method according to item Y7, wherein the one or more plant fungal pathogens or plant bacterial pathogens are from a genus selected from the group consisting of Fusarium, Botrytis, Erwinia, Dickeya, Agrobacterium, Xanthomonas, Xylella, Candidatus, Sclerotinia, Cercospora/Cercosporidium, Uncinula, Podosphaera, Phomopsis, Alternaria, Pseudomonas, Phytophthora, Phakopsora, Aspergillus, Uromyces, Cladosporium, Rhizopus, Penicillium, Rhizoctonia, Macrophomina, Mycosphaerella, Magnaporthe, Monilinia, Colletotrichum, Diaporthe, Corynespora, Gymnosporangium, Schizothyrium, Gloeodes, Botryosphaeria, Neofabraea, Wilsonomyces, Sphaerotheca, Erysiphe, Stagonospora, Venturia, Ustilago, Claviceps, Tilletia, Phoma, Cochliobolus, Gaeumanomyces, Rhychosporium, Biopolaris, and Helminthosporium, and combinations thereof.
Y9. The method according to any one of items Y7 or Y8, wherein the one or more plant fungal pathogens or plant bacterial pathogens are from a species selected from the group consisting of Botrytis cinerea, Botrytis squamosa, Erwinia carotovora, Erwinia amylovora, Dickeya dadantii, Dickeya solani, Agrobacterium tumefaciens, Xanthomonas axonopodis, Xanthomonas campestris pv. carotae, Xanthomonas pruni, Xanthomonas arboricola, Xanthomonas oryzae pv. oryzae, Xylella fastidiosa, Candidatus liberibacter, Fusarium culmorum, Fusarium graminearum, Fusarium oxysporum, Fusarium oxysporum f. sp. Cubense, Fusarium oxysporum f. sp. Lycopersici, Fusarium virguliforme, Sclerotinia sclerotiorum, Sclerotinia minor, Sclerotinia homeocarpa, Uncinula necator, Podosphaera leucotricha, Podosphaera clandestine, Phomopsis viticola, Alternaria tenuissima, Alternaria porri, Alternaria alternate, Alternaria solani, Alternaria tenuis, Pseudomonas syringae pv. Tomato, Phytophthora infestans, Phytophthora parasitica, Phytophthora capsici, Phytophthora cinnamon, Phytophthora fragariae, Phytophthora ramorum, Phytophthora palmivara, Phytophthora nicotianae, Phakopsora pachyrhizi, Phakopsora meibomiae, Aspergillus flavus, Aspergillus niger, Uromyces appendiculatus, Cladosporium herbarum, Rhizoctonia solani, Macrophomina phaseolina, Mycosphaerella graminocola, Mycosphaerella fijiensis, Mycosphaerella pomi, Mycosphaerella citri, Magnaporthe oryzae, Magnaporthe grisea, Monilinia fruticola, Monilinia vacciniicorymbosi, Monilinia laxa, Colletotrichum gloeosporiodes, Colletotrichum acutatum, Coletotrichum candidum, Diaporthe citri, Corynespora cassiicola, Gymnosporangium juniperi-virginianae, Schizothyrium pomi, Gloeodes pomigena, Botryosphaeria dothidea, Wilsonomyces carpophilus, Sphaerotheca macularis, Sphaerotheca pannosa, Stagonospora nodorum, Venturia inaequalis, Ustilago nuda, Ustilago maydis, Ustilago scitaminea, Claviceps pupurea, Tilletia tritici, Tilletia laevis, Tilletia horrid, Tilletia controversa, Phoma glycinicola, Phoma exigua, Phoma lingam, Cochliobolus sativus, Gaeumanomyces gaminis, Rhychosporium secalis, Helminthosporium secalis, Helminthosporium maydis, Helminthosporium solani, and Helminthosporium triticirepentis, and combinations thereof.
Y10. The method according to any one of items Y1-Y9, wherein the one or more phytopathogens are one or more plant fungal pathogens.
Y11. The method according to any one of items Y7-Y10, wherein the one or more plant fungal pathogens are Fusarium graminearum, Fusarium culmorum or Botrytis cinerea.
Y12. The method according to any one of items Y1-Y11, wherein the Bacillus amyloliquefaciens strain is in the form of spores or vegetative cells.
Y13. The method according to any one of items Y1-Y12, wherein the Bacillus amyloliquefaciens strain is in the form of spores.
Y14. The method according to any one of items Y1-Y13, wherein the fermentation product comprises one or more metabolites.
Y15. The method according to item Y14, wherein the metabolites are lipopeptides.
Y16. The method according to item Y15, wherein the lipopeptides are selected from the group consisting of iturins, fengycins and surfactins, and combinations thereof.
Y17. The use according to any of items Y15 or Y16, wherein the lipopeptides comprise fengycins and iturins.
Y18. The method according to any one of items Y15 or Y16, wherein the lipopeptides comprise surfactins and fengycins.
Y19. The method according to any one of items Y15 or Y16, wherein the lipopeptides comprise surfactins and iturins.
Y20. The method according to any of items Y15-Y19, wherein the total concentration of lipopeptides in the fermentation product is about 2500-30000 μg/ml in a medium originally containing 30 g/L of carbon source.
Y21. The method according to any of items Y16-Y20, wherein the concentration of surfactins in the fermentation product is about 1200-15000 μg/ml.
Y22. The method according to any of items Y16-Y21, wherein the concentration of fengycins in the fermentation product is about 700-6500 μg/ml.
Y23. The method according to any of items Y16-Y22, wherein the concentration of iturins in the fermentation product is about 500-4500 μg/ml.
Y24. The method according to any one of items Y1-Y23, wherein the composition further comprises one or more agrochemically acceptable excipients carriers, surfactants, dispersants and yeast extracts.
Y25. The method according to any one of items Y1-Y24, wherein the composition further comprises one or more active ingredients.
Y26. The method according to item Y25, wherein the one or more active ingredients are of microbial, biological or chemical origin.
Y27. The method according to any one of items Y25 or Y26, wherein the one or more active ingredients are selected from the group consisting of an insecticide, fungicide, nematicide, bactericide, herbicide, plant extract, plant growth regulator, a plant growth stimulator, and fertilizer.
Y28. The method according to item Y27, wherein the insecticide is selected from the group consisting of pyrethroids, bifenthrin, tefluthrin, zeta-cypermethrin, organophosphates, chlorethoxyphos, chlorpyrifos, tebupirimphos, cyfluthrin, fiproles, fipronil, nicotinoids, and clothianidin, and combinations thereof.
Y29. The method according to any one of items Y27 or Y28, wherein the fungicide is selected from the group consisting of fluopyram plus tebuconazole, chlorothalonil, thiophanate-methyl, prothioconazole, metalaxyl, and copper hydroxide, and combinations thereof.
Y30. The method according to any one of items Y25-Y29, wherein the one or more active ingredients are selected from a second strain of bacteria different from the Bacillus amyloliquefaciens strain.
Y31. The method according to item Y30, wherein said second strain of bacteria is a biostimulant strain, preferably a biostimulant Bacillus strain.
Y32. The method according to any one of items Y30 or Y31, wherein said second strain of bacteria is of a species selected from the group consisting of Bacillus velezensis, Bacillus paralicheniformis, Bacillus amyloliquefaciens, and Bacillus subtilis.
Y33. The method according to any one of items Y1-Y32, wherein the composition is in a form selected from the group consisting of a liquid, a wettable powder, a granule, a spreadable granule, a wettable granule, and a microencapsulation.
Y34. The method according to any one of items Y1-Y33, wherein the composition is a liquid formulation.
Y35. The method according to any one of items Y1-Y34, wherein the composition further comprises a coating polymer.
Y36. The method according to any one of items Y1-Y35, wherein the plant is selected from the group consisting of a crop, a monocotyledonous plant, a dicotyledonous plant, a tree, an herb, a bush, a grass, a vine, a fern, and a moss.
Y37. The method according to any one of items Y1-Y36, wherein the plant is selected from the group consisting of wheat, barley, oats, small cereal grains, corn, rice, sugar cane, soybean, potato, carrot, coffee and banana.
Y38. The method according to any one of items Y1-Y37, wherein inhibiting growth of one or more phytopathogens leads to improve seedling vigor, improved root development, improved plant growth, improved plant health, increased yield, improved appearance, reduced pathogenic infection, or a combination thereof.
Z1. A kit for use in inhibiting growth of one or more phytopathogens on a plant, said kit comprising:
a composition comprising:
   (i) a Bacillus amyloliquefaciens strain or a variant thereof, and/or
   (ii) a fermentation product produced by a Bacillus amyloliquefaciens strain or a variant thereof,
optionally, instructions for use,
   wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021.
Z2. The kit according to item Z1, wherein the composition comprises the fermentation product produced by the Bacillus amyloliquefaciens strain or a variant thereof.
Z3. The kit according to any one of items Z1 or Z2, wherein the composition comprises:
   (i) the Bacillus amyloliquefaciens strain or a variant thereof, and
   (ii) the fermentation product produced by the Bacillus amyloliquefaciens strain or a variant thereof.
Q1. A kit comprising:
   a composition comprising:
      (i) a Bacillus amyloliquefaciens strain or a variant thereof, and/or
      (ii) a fermentation product produced by a Bacillus amyloliquefaciens strain or a variant thereof,
   optionally, instructions for use,
      wherein the Bacillus amyloliquefaciens strain is deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021, and
      wherein the kit is for use in inhibiting growth of one or more phytopathogens on a plant.
Q2. The kit according to item Q1, wherein the composition comprises the fermentation product produced by the Bacillus amyloliquefaciens strain or a variant thereof.
Q3. The kit according to any one of items Q1 or Q2, wherein the composition comprises:
   (i) the Bacillus amyloliquefaciens strain or a variant thereof, and
   (ii) the fermentation product produced by the Bacillus amyloliquefaciens strain or a variant thereof.

The invention will now be described in further details in the following non-limiting examples.

### EXAMPLES

### Example 1: Screening of Bacillus Strains for Inhibitory Effect Against Fusarium culmorum

Bacillus spp. are well known biocontrol agents of phytopathogens and have been described to produce a vast array of bioactive metabolites with inhibitory effects over pathogenic species growth. Bacillus strains differ in the genomic potential for biosynthesis of bioactive metabolites and on the respective regulation of gene expression, and therefore can produce different combinations of bioactive metabolites with different inhibitory effects against specific pathogens.

### Method

A high throughput screening scheme was set up to identify Bacillus strains with inhibitory effect on phytopathogens from a library containing 600 candidate Bacillus strains. All strains were screened for inhibitory effect on Fusarium culmorum. The inhibitory potency of Bacillus strains against filamentous fungi was evaluated by two different in vitro methods: one based on co-cultivation, where fungi and bacteria grow together on solid medium, competing for space and nutrients; another based on Bacillus capacity of producing bioactive metabolites and their impact on fungal growth in liquid medium. The two screening methods have been described extensively in Kjeldgaard et al. (2022).

### Results

The inhibition screening campaign identified one primary candidate of the species Bacillus amyloliquefaciens which displayed promising biofungicide properties. The strain has been deposited as DSM34003 at Deutsche Sammlung von Mikroorganismen und Zellkulturen GmbH (DSMZ), Inhoffenstr. 7B, D-38124 Braunschweig, Germany, by Chr. Hansen A/S, Hørsholm, Denmark on 24 Aug. 2021. The performance of Bacillus amyloliquefaciens strain DSM34003 against a selection of pathogenic fungi is described in the following examples. The fermentation product of the Bacillus amyloliquefaciens strain DSM34003 is referred to as FUNGI-FOL herein.

### Conclusion

The inhibition screening campaign resulted in the identification of main biofungicide candidate Bacillus amyloliquefaciens strain DSM34003.

### Example 2: Effect of FUNGI-FOL on Growth of Phytopathogens Fusarium graminearum and Botrytis cinerea

The bioactivity of FUNGI-FOL against F. graminearum and B. cinerea was benchmarked against fermentation products from well-known biocontrol commercial strains (A-B), including Bacillus amyloliquefaciens strain QST 713 (Serenade® ASO fungicide, Bayer, USA), Bacillus velezensis type strain FZB42 (RhizoVital®42, ABiTEP GmbH, Berlin, Germany) and Bacillus velezensis strain FZB24 (Taegro®, Novozymes/Syngenta, Denmark).

### Method

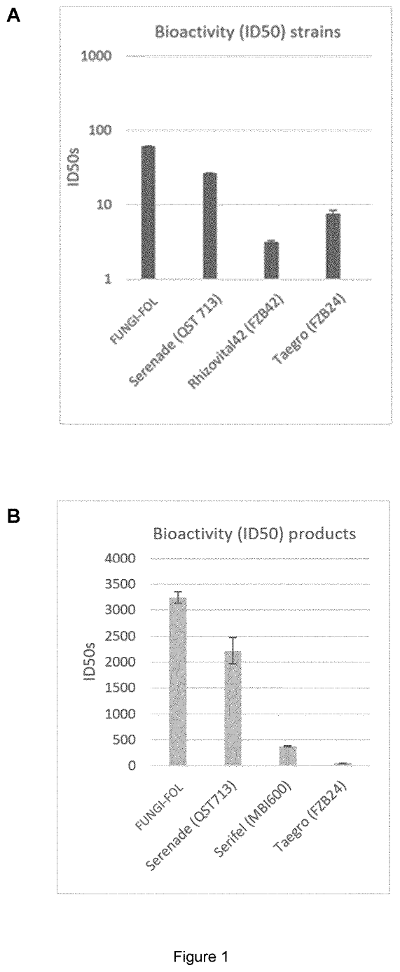

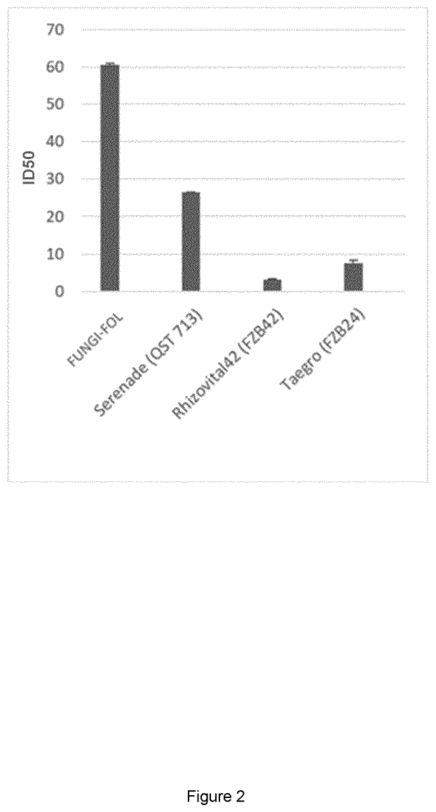

Growth inhibition of phytopathogenic filamentous fungi F. graminearum (FIG. 1) and B. cinerea (FIG. 2) by metabolites present in bacterial cultures of FUNGI-FOL or commercial strains (Serenade, Rhizovital, Taegro) grown in LB medium was assayed.

First, the inhibitory effect of the fermentation product of B. amyloliquefaciens strain DSM34003 (FUNGI-FOL) and fermentation products of a set of commercial strains were assayed.

A dilution series of bacterial culture samples were added to 48-well microtiter plates containing potato dextrose broth (PDB) medium and a fixed fungal spore concentration. Bacterial growth was inhibited by presence of bacteriostatic antibiotics in the culture medium (Cam and Tet, at 50 and 10 μg/ml, respectively). Plates were incubated at 25° C. without shaking for 60 h (in dark conditions) and fungal growth was measured by spectrophotometry at 600 nm. The dilution factor at which each strain derivative inhibits 50% of the maximal fungal growth (ID50) were used as a measure of inhibition potency. ID50 values were determined by sigmoid regression of experimental data obtained from in vitro fungal inhibition assays with different dilution factors (FIG. 1A).

Experiments were done as biologically independent duplicates and results represented correspond to the averages and standard deviations calculated from results.

The FUNGI-FOL prototype product (concentrated fermentation product) and commercial products (Serenade, Serifel, Taegro) were also examined for their inhibitory effect on F. graminearum. The methodology as described above were repeated and the bioactivity levels (ID50s) were determined accordingly (FIG. 1B).

### Results

F. graminearum and B. cinerea growth inhibition profiles by bacterial cultures compared between FUNGI-FOL and fermentation products of commercial strains (Serenade, Rhizovital, Taegro) showed that the fungal inhibition potential of FUNGI-FOL was higher or at par with well-known biocontrol strains. ID50 values calculated from those experimental results confirmed the similar or superior biocontrol potential of FUNGI-FOL (FIGS. 1A and 2). In particular, FUNGI-FOL had ID50 values which were greatly improved compared to fermentation products from Serenade strain QST 713, Rhizovital strain FZB42 and Taegro strain FZB24.

Finally, biocontrol potency compared between the FUNGI-FOL prototype product and commercially available biofungicide products (Serenade, Serifel, Taegro) confirmed the better performance of the FUNGI-FOL prototype product in inhibition of F. graminearum growth (FIG. 1B).

### Conclusion

Experimental results comparing the inhibition potency at the strain or product level between FUNGI-FOL and well described biocontrol strains/products confirmed the great performance of this strain as biocontrol agent to inhibit the causative agent of Fusarium Head Blight (FHB) disease, Fusarium graminearum, and the causative agent of gray mold disease, B. cinerea.

### Example 3: Production of Lipopeptides by the FUNGI-FOL Prototype Product and their Effect on Phytopathogens Growth

The FUNGI-FOL prototype product was examined with regards to lipopeptide production to elucidate any potential correlation with biofungicide effect. To further explore the potential synergistic effect between bioactive metabolites assays with single families of bioactive compounds and their combinations were performed.

### Methods

### Quantification of Lipopeptides

Samples of the FUNGI-FOL prototype product were analyzed by LC-MS to quantify the concentrations of the three families of lipopeptides (surfactins, iturins and fengycins).

Biocontrol product samples were first thoroughly mixed by vortexing followed by transfer of 150 μL of culture broth to a 1.5 mL Eppendorf tube already containing 40 μL of ₁₃C-labeled bioactive metabolites and 810 μL of isopropanol. The mixture was ultrasonicated for 10 min on ice and mixed in a rotatory mixer for 20 min to ensure an effective extraction of the metabolites. Samples were centrifuged at 15,000 rpm for 3 min at 4° C. and 100 μL of supernatant was used for LC-MS analysis.

### Inhibitory Effect of Lipopeptides

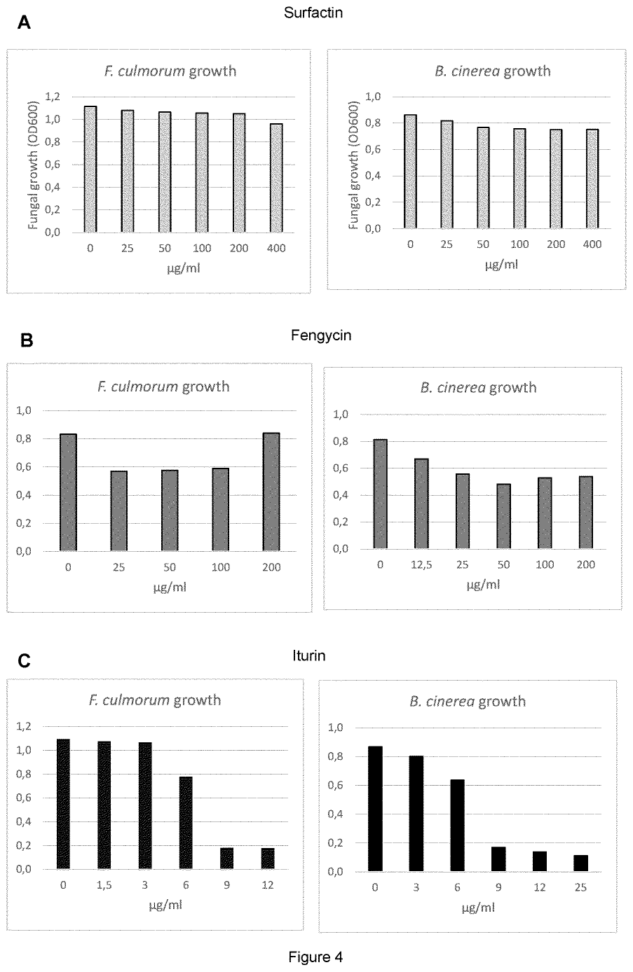

Increasing concentrations of pure stocks of surfactin (Sigma S3523, FIG. 4A), fengycin (Sigma SMB00292, FIG. 4B) or iturin (Sigma 11774, FIG. 4C) were added to 48-well microtiter plates containing PDB medium and a fixed fungal spore concentration. Inhibitory effect over two different phytopathogenic species was assayed, F. culmorum (FIG. 4, left) and B. cinerea (FIG. 4, right). Plates were incubated at 25° C. without shaking for 60 hours (in dark conditions) and fungal growth was measured by spectrophotometry at 600 nm. Experiments were carried out in biological duplicates with no major variations in inhibition potency of the tested strains.

### Results

### Quantification of Lipopeptides

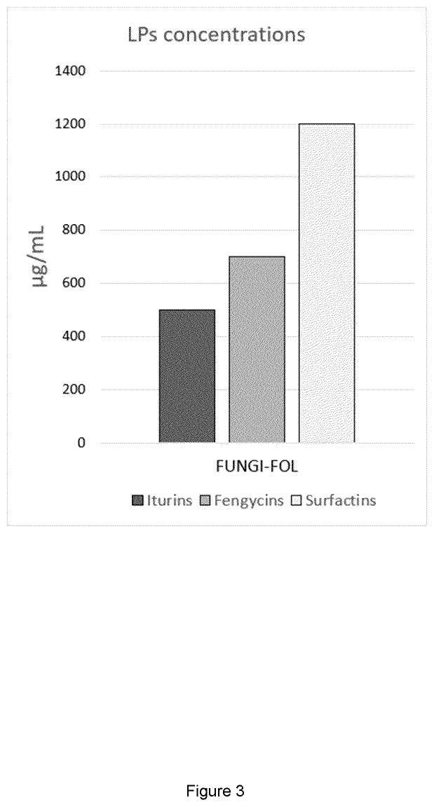

The FUNGI-FOL prototype product comprised high levels of all lipopeptides (iturins, fengycins and surfactins) (FIG. 3). Given that FUNGI-FOL had higher bioactivity than all the commercial strains (see Example 2), then the inhibitory effect of lipopeptides and their interplay were further investigated.

### Inhibitory Effect of Lipopeptides

Both fengycins and iturins showed potent inhibition of fungal growth, while surfactins only compromised pathogen growth very weakly. Iturin addition strongly inhibited the growth of the two phytopathogenic species tested to a very low effective concentration of 9 μg/ml (FIG. 4C). The inhibitory effect of fengycin alone on the growth of the three pathogens was consistently observed, although the concentrations required to reach 50% growth inhibition were higher than for iturin, ranging from 12.5 to 50 μg/ml final concentration (FIG. 4B). This lower potency of inhibition observed for fengycin could potentially be related to lack of solubility of this compound when applied alone to a fungal growth medium. Finally, the inhibitory effect of surfactin was very modest and barely decreased the growth of the pathogens assayed even at high concentrations (200-400 μg/ml) (FIG. 4A).

Combinations of different concentrations of surfactin and fengycin were tested to determine if this combination of lipopeptides could be the origin of the superior performance of FUNGI-FOL. Fungal growth inhibition of increasing concentrations of single compounds was compared with compound combinations, where a fixed concentration of one of them was assayed in combination with increasing concentrations of the second metabolite.

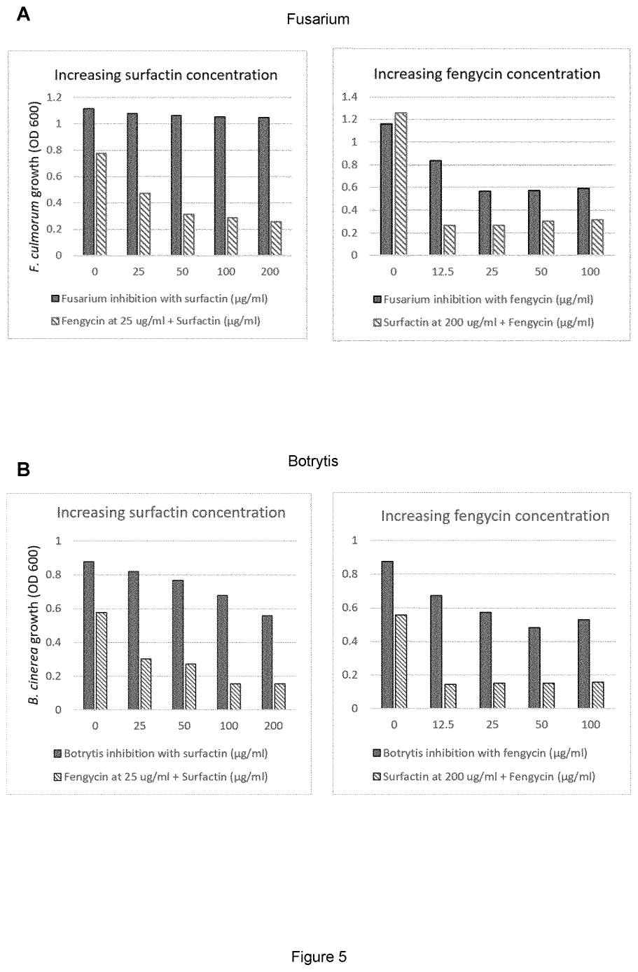

For both filamentous fungi, F. culmorum and B. cinerea the bioactivity of fengycin increased up to 6-fold in the presence of surfactin. At surfactin concentrations of 100-200 μg/ml, the effective concentration of fengycin required to inhibit the tested phytopathogens growth decreased to 12.5 μg/ml (FIG. 5, right). The ratio of surfactin/fengycin concentration of 1 to 16 (at >10 μg/ml fengycin) revealed a synergistic inhibitory effect over fungal phytopathogens. The enhanced bioactivity of fengycin could potentially be triggered by other surfactants, either produced by the Bacillus or supplemented to the fermentation process, formulation or application stages.

### Conclusion

This example demonstrates that there is a strong correlation between the higher bioactivity values (ID50) quantified in FUNGI-FOL compared to those of the commercial biocontrol products, and the high concentrations of bioactive compounds, namely the lipopeptides fengycins, surfactins and iturins. In particular, the combination of surfactin and fengycin generated a synergistic inhibitory effect to fungal growth.

### Example 4: In Vivo Bioactivity Assessment of FUNGI-FOL on FHB

The biofungicidal effect of FUNGI-FOL was tested on spring wheat plants and compared to commercial biocontrol products (Serenade, Taegro, Serifel, Polyversum).

### Methods

### Test of Dosage Effect

Spring wheat plants were grown until flowering stage. Spikes were sprayed with FUNGI-FOL spore solutions at different concentrations (% v/v) using a hand-held spraying gun. 15-20 spikes were assayed per treatment. After drying (1 hour later), plants were sprayed with a Fusarium graminearum spore solution (1×10⁵ spores/ml). Plants were then placed in a humid chamber at 30° C. and 100% relative humidity for 48 hours. Afterwards, plants were taken to greenhouse conditions and Fusarium Head Blight (FHB) disease symptoms were assessed 7 days after spraying by quantifying the proportion of each spike with Fusarium infection symptoms.

### Comparison to Commercial Biocontrol Products

Experiments were conducted as described above, with the exception that commercially available biofungicide products (Serenade, Taegro, Serifel, Polyversum) were also included by applying at label dosages. 60-80 spikes were assayed per treatment. Disease incidence was calculated by quantifying the proportion of spikes that show any infection by Fusarium in respect to all the spikes treated. Disease severity was calculated by quantifying the average degree of infection of the spikes among all the spikes with Fusarium symptoms.

### Results

### Test of Dosage Effect

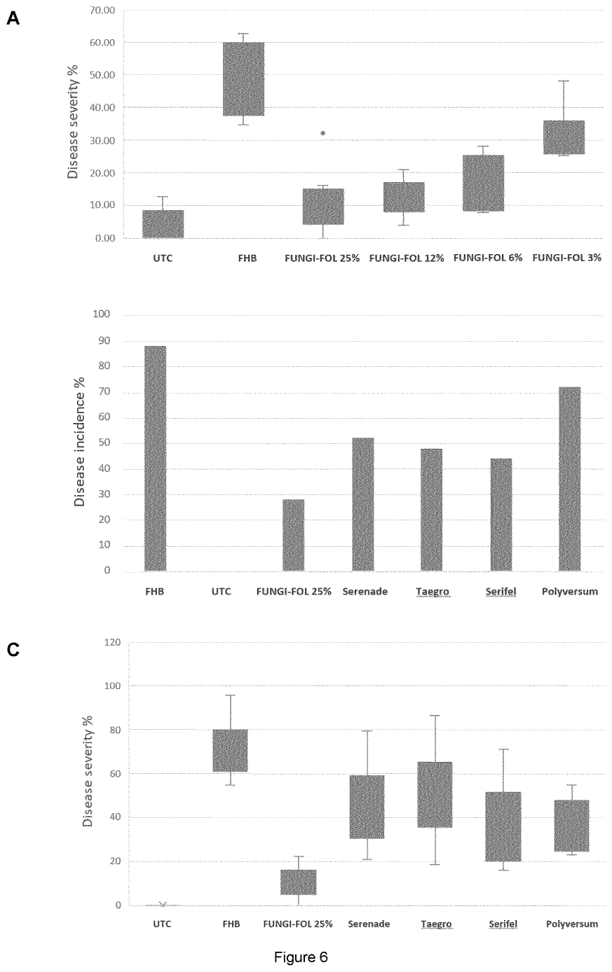

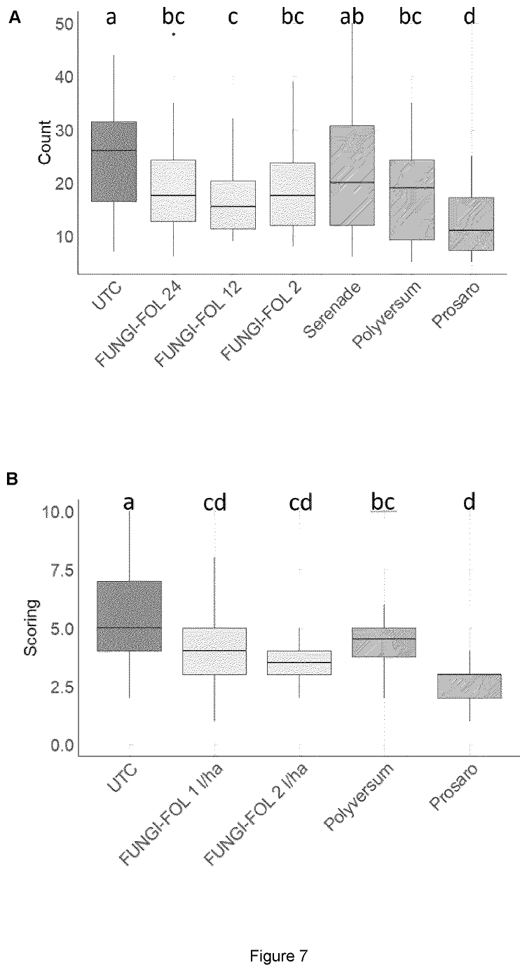

Disease severity was reduced when plants were pre-sprayed with FUNGI-FOL spore solutions at all dosages (FIG. 6A). Highest dose (25% (v/v)) yielded the biggest reduction in disease severity, approximately 80% with respect to the FHB control not treated with FUNGI-FOL spore solution. UTC corresponds to untreated control spikes.

### Comparison to Commercial Biocontrol Products

Disease incidence was reduced when plants were pre-sprayed with FUNGI-FOL spore solution. Approximately, a 60% reduction compared to the FHB control (FIG. 6B). Similarly, disease severity was reduced when plants were pre-sprayed with FUNGI-FOL spore solution. An approximate decrease of 70% in disease severity reduction was measured compared to the FHB control (FIG. 6C).

All of the commercial biocontrol products reduced both disease incident and disease severity, but none of them to the same extent as FUNGI-FOL. In particular, of the plants with disease symptoms, FUNGI-FOL decreased the disease severity with at least 50% compared to the commercial biocontrol products (FIG. 6C).

### Conclusion

This example demonstrates that a markedly reduction of Fusarium Head Blight (FHB) infection on wheat spikes can be achieved by treatment with FUNGI-FOL fermentation concentrate. There is a correlation between level of efficacy and the concentration of FUNGI-FOL product applied, showing the potency as biofungicide.

FUNGI-FOL reduced both disease incident and disease severity to significantly lower levels than current commercially available biological alternatives for controlling FHB in plants.

### Example 5: Multiple Year Field Level Assessment of the Bioactivity of FUNGI-FOL Against Fusarium Head Blight

The bio fungicidal effect of FUNGI-FOL was tested at the field level on spring wheat one year and in winter wheat the year after. In these trials, FUNGI-FOL's performance was compared to the commercial biocontrol products Serenade, Polyversum and the chemical reference product Prosaro.

### Methods

The spring wheat trial was conducted in Flakkebjerg, Denmark, in three exact replicates using the variety Diskett shown in 1 square meter plots replicated 6 times per treatment and drilled on the 10th and 25th of April and 10th of May. Treatments were applied at 50% flowering (during the morning of the 24th of June and 5th and 14th of July) with a self-propelled field sprayer at rates of 2, 12 and 24 liters per ha and a total spray volume of 200 l/ha. A chemical reference product, Prosaro, and two biological reference products, Serenade and Polyversum, were applied in the same way at label dosages. All trials were inoculated with a mixture of F. graminearum and F. culmorum (10 ml per plot with 2×10⁵ spores per ml) on the same day as product applications and all trials were mist irrigated to ensure a continuous moisture distribution for disease progression. Disease incidence assessments were done three weeks after application by reporting the number of infected heads out of 100 heads per plot assessed. A score for the severity of the attach was also given. Due to the small plot size, this trial was not harvested. The data was analyzed with a generalized linear mixed effects model with family poisson and sowing timepoint as random factor, p<0.05.

The winter wheat trial was also conducted in Flakkebjerg, Denmark, in three exact replicates. In that trial 3 different varieties of winter wheat were shown; KWS Cleveland, Rembrandt and Chevignon in 20 square meter plots replicated 6 times per treatment. Treatments were applied at 50% flowering with a self-propelled field sprayer at commercially viable rates of 1 and 2 liters per ha and a total spray volume of 200 l/ha. A chemical reference product, Prosaro, and a biological reference product, Polyversum, were applied in the same way at label dosages. All trials were inoculated with a mixture of F. graminearum and F. culmorum (100 ml per plot with 2×10⁵ spores per ml) on the same day as product applications and all trials were mist irrigated to ensure a continuous moisture distribution for disease progression.

Four times one meter row per plot were assessed and numbers of attacked heads per meter counted. A score for the severity of the attack was also given.

Data analysis was done applying a linear mixed model with location as random factor, p<0.05.

### Results

### Spring Wheat Trial

Disease incidence was significantly reduced compared to the untreated control (UTC) when plants were treated with FUNGI-FOL at all three rates (FIG. 7A). FUNGI-FOL efficacy tended to be higher, compared to Serenade and was on-par with Polyversum. The chemical standard Prosaro had a higher efficacy compared to FUNGI-FOL and the other biological standard treatments with Serenade and Polyversum. There was no difference in disease severity between any of the treatments.

### Winter Wheat Trial

At both commercially viable rates tested, FUNGI-FOL treatments reduced disease incidence significantly compared to UTC (FIG. 7B). FUNGI-FOL efficacy had a tendency to be higher, compared to the biological market standard Polyversum. The chemical standard Prosaro had a significantly higher efficacy, compared to the biological market standard Polyversum, but performed comparable to FUNGI-FOL.

There was no difference in disease severity or yield between any of the treatments.

### Conclusion

These six field trials with FUNGI-FOL across two years demonstrate a robust disease control of FUNGI-FOL across crop species, varieties and sowing (and thereby flowering) time. The efficacy was comparable or better than currently available biological alternatives and even showed potential in the winter wheat trial to reach efficacy levels comparable to wide-used conventional chemistry.

### REFERENCES

Altschul et al. (1990), J. Mol. Biol., 215, 403-410
Kjeldgaard et al. (2022), Microbiol. Spectr., 10, e0143321

### DEPOSITS AND EXPERT SOLUTION

The applicant requests that a sample of the deposited microorganism stated in table I below may only be made available to an expert, until the date on which the patent is granted.

The applicant requests that the availability of the deposited microorganism referred to in Rule 33 EPC shall be effected only by the issue of a sample to an independent expert nominated by the requester (Rule 32(1) EPC). If an expert solution has been requested, restrictions concerning the furnishing of samples apply.

The deposit was made according to the Budapest treaty on the international recognition of the deposit of microorganisms for the purposes of patent procedure at Deutsche Sammlung von Mikroorganismen und Zellkulturen GmbH (DSMZ), Inhoffenstr. 7B, D-38124 Braunschweig, Germany.

The Budapest Treaty provides that any restriction of public access to samples of deposited biological material must be irrevocably removed as of the date of grant of the relevant patent.

TABLE I
Deposited strain made at a depositary institution.

| Strain | Accession no. | Deposit date |
|---|---|---|
| Bacillus amyloliquefaciens | DSM34003 | 24 Aug. 2021 |

1-15. (canceled)

16. A method comprising treating one or more surfaces of a plant with a Bacillus component selected from:
(a) Bacillus amyloliquefaciens DSM 34003; and
(b) fermentation products produced by Bacillus amyloliquefaciens DSM 34003.

17. The method of claim 16, wherein said Bacillus component comprises spores of Bacillus amyloliquefaciens DSM 34003.

18. The method of claim 16, wherein said Bacillus component comprises a fermentation product produced by Bacillus amyloliquefaciens DSM 34003.

19. The method of claim 16, wherein said Bacillus component is substantially free of bacterial cells and bacterial spores.

20. The method of claim 16, wherein said Bacillus component comprises bioactive metabolites produced by Bacillus amyloliquefaciens DSM 34003.

21. The method of claim 16, wherein said Bacillus component comprises bioactive lipopeptides produced by Bacillus amyloliquefaciens DSM 34003.

22. The method of claim 16, wherein said Bacillus component comprises bioactive iturins, fengycins and surfactins produced by Bacillus amyloliquefaciens DSM 34003.

23. The method of claim 16, wherein said Bacillus component is applied in an amount/concentration sufficient to inhibit growth of one or more phytopathogenic fungi.

24. The method of claim 16, wherein said Bacillus component is applied in an amount/concentration sufficient to inhibit growth of one or more phytopathogenic oomycetes.

25. The method of claim 16, wherein said Bacillus component is applied in an amount/concentration sufficient to inhibit growth of one or more Botrytis and/or Fusarium.

26. The method of claim 16, wherein said Bacillus component is applied by spraying said plant with a composition comprising said Bacillus component.

27. The method of claim 16, wherein said Bacillus component is applied to leaves and/or fruits of said plant.

28. A kit comprising:
a composition comprising a Bacillus component selected from Bacillus amyloliquefaciens DSM 34003 and fermentation products derived from Bacillus amyloliquefaciens DSM 34003; and
instructions for applying said composition to a plant.

29. The kit of claim 28, wherein said composition is a liquid.

30. The kit of claim 28, wherein said composition is a powder or granule.

31. The kit of claim 28, wherein said Bacillus component is present in said composition in an amount sufficient to inhibit growth of one or more phytopathogens when said composition is applied to one or more surfaces of a plant.

32. The kit of claim 28, wherein said composition further comprises at least one additional active selected from:
(i) biological pesticides;
(ii) chemical pesticides;
(iii) fertilizers;
(iv) plant biostimulants;
(v) plant growth promoting agents; and
(vi) plant growth regulators.
